(19) United States
(12) Patent Application Publication
(10) Pub. No.: US 2023/0373863 A1
(43) Pub. Date: Nov. 23, 2023

(54) CORDIERITE SINTERED BODY AND METHOD FOR PRODUCING SAME

(71) Applicant: AGC Inc., Tokyo (JP)

(72) Inventors: Shuhei OGAWA, Chiyoda-ku (JP); Naomichi MIYAKAWA, Chiyoda-ku (JP)

(73) Assignee: AGC Inc., Tokyo (JP)

(21) Appl. No.: 18/363,788

(22) Filed: Aug. 2, 2023

Related U.S. Application Data
(63) Continuation of application No. PCT/JP2022/007888, filed on Feb. 25, 2022.

(30) Foreign Application Priority Data
Mar. 5, 2021 (JP) 2021-035458

(51) Int. Cl. C04B 35/195; C04B 35/64; C04B 35/63; C09K 5/14

(52) U.S. Cl. CPC C04B 35/195; C04B 35/64; C04B 35/6303; C09K 5/14; C04B 2235/3481; C04B 2235/3463; C04B 2235/3206; C04B 2235/3208; C04B 2235/5436; C04B 2235/9607

(57) ABSTRACT

The present invention relates to a cordierite sintered body including all elements belonging to an element group M1 consisting of calcium, magnesium, aluminum, and silicon, in which a content of the calcium is 0.06 mass % or more and 3.40 mass % or less in terms of oxide, a content of the magnesium is 12.9 mass % or more in terms of oxide, a content of an element M2, which is a metal element other than the elements belonging to the element group M1, is 1.5 mass % or less in terms of oxide, a porosity is 3.0 vol % or less, a four-point bending strength is 170 MPa or more, and a Weibull coefficient is 9.5 or more.

### CROSS-REFERENCE TO RELATED APPLICATIONS

This is a continuation of International Application No. PCT/JP2022/007888 filed on Feb. 25, 2022, and claims priority from Japanese Patent Application No. 2021-035458 filed on Mar. 5, 2021, the entire content of which is incorporated herein by reference.

### TECHNICAL FIELD

The present invention relates to a cordierite sintered body and a method for producing the same.

### BACKGROUND ART

In the related art, a sintered body containing cordierite (cordierite sintered body) has been used as a member to be exposed to plasma (Patent Literature 1).

### CITATION LIST

### Patent Literature

Patent Literature 1: JPH09-295863A

### SUMMARY OF INVENTION

### Technical Problem

As a result of investigations by the inventors of the present invention, the cordierite sintered body in the related art sometimes has insufficient plasma resistance.

Further, the cordierite sintered body is sometimes required to have excellent thermal shock resistance depending on the uses thereof.

The present invention has been made in view of the above points, and an object thereof is to provide a cordierite sintered body having excellent plasma resistance and thermal shock resistance, and a method for producing the same.

### Solution to Problem

As a result of intensive studies, the inventors of the present invention have found that the above object can be achieved by adopting the following configuration, and have completed the present invention.

That is, the present invention provides the following (1) to (11).
(1) A cordierite sintered body including all elements belonging to an element group M1 consisting of calcium, magnesium, aluminum, and silicon,
   in which a content of the calcium is 0.06 mass % or more and 3.40 mass % or less in terms of oxide,
   a content of the magnesium is 12.9 mass % or more in terms of oxide,
   a content of an element M2, which is a metal element other than the elements belonging to the element group M1, is 1.5 mass % or less in terms of oxide,
   a porosity is 3.0 vol % or less,
   a four-point bending strength is 170 MPa or more, and
   a Weibull coefficient is 9.5 or more.
(2) The cordierite sintered body according to the above (1), in which the content of the calcium is 0.09 mass % or more and 1.80 mass % or less in terms of oxide.
(3) The cordierite sintered body according to the above (1) or (2), in which a content of the aluminum is 39.0 mass % or less in terms of oxide.
(4) The cordierite sintered body according to any one of the above (1) to (3), in which a content of titanium is 0.5 mass % or less in terms of oxide.
(5) The cordierite sintered body according to any one of the above (1) to (4), in which a total content of iron, nickel, chromium, and manganese is 0.6 mass % or less in terms of oxide.
(6) The cordierite sintered body according to any one of the above (1) to (5), in which a content of an alkali metal is 0.30 mass % or less in terms of oxide.
(7) The cordierite sintered body according to any one of the above (1) to (6), in which a thermal conductivity is 4.0 W/(mK) or more.
(8) The cordierite sintered body according to any one of the above (1) to (7), in which the number of foreign particles containing the element M2 and having an equivalent circle diameter of 5 μm or more is 150/cm² or less.
(9) A method for producing the cordierite sintered body according to any one of the above (1) to (8), the method including:
   preparing a molded body using a raw material powder; and
   heating the molded body,
   in which as the raw material powder, a mixed powder including a cordierite powder produced by an electric melting method, a mullite powder, and a magnesia powder is used.
(10) The method for producing a cordierite sintered body according to the above (9), in which the mixed powder further includes a calcium oxide powder.
(11) The method for producing a cordierite sintered body according to the above (9) or (10), in which the cordierite powder is subjected to magnetic separation before use.

### Advantageous Effects of Invention

According to the present invention, it is possible to provide a cordierite sintered body having excellent plasma resistance and thermal shock resistance, and a method for producing the same.

### DESCRIPTION OF EMBODIMENTS

The terms used in the present invention have the following meanings.

A numerical range represented using “to” means a range including numerical values described before and after “to” as a lower limit value and an upper limit value.

[Sintered Body]

A cordierite sintered body according to the present invention contains all elements belonging to an element group M1 consisting of calcium, magnesium, aluminum, and silicon, in which a content of calcium is 0.06 mass % or more and 3.40 mass % or less in terms of oxide, a content of magnesium is 12.9 mass % or more in terms of oxide, a content of an element M2, which is a metal element other than the elements belonging to the element group M1, is 1.5 mass % or less in terms of oxide, a porosity is 3.0 vol % or less, a four-point bending strength is 170 MPa or more, and a Weibull coefficient is 9.5 or more.

Hereinafter, the cordierite sintered body is simply referred to as a “sintered body”, and the cordierite sintered body according to the present invention is also referred to as “the present sintered body”.

The present sintered body is a sintered body of a metal oxide containing cordierite.

A chemical formula representing the cordierite includes, but is not limited to, 2MgO·2Al₂O₃·5SiO₂, for example.

The present sintered body generally contains a specific amount of calcium (Ca) in addition to the cordierite (2MgO·2Al₂O₃·5SiO₂). In addition, the present sintered body has a higher content of magnesium (Mg) than general cordierite.

Further, the present sintered body exhibits specific values of porosity, four-point bending strength, and Weibull coefficient.

The present sintered body has excellent plasma resistance and thermal shock resistance.

Hereinafter, the present sintered body will be described in more detail.

<Element Group M1>

As described above, the present sintered body contains calcium (Ca) in addition to the cordierite (2MgO·2Al₂O₃·5SiO₂).

Therefore, the present sintered body contains all elements belonging to an element group M1, which is a metal element group consisting of calcium (Ca), magnesium (Mg), aluminum (Al), and silicon (Si).

<<Ca>>

For the reason that the present sintered body has excellent plasma resistance, the content of Ca is 0.06 mass % or more, preferably 0.09 mass % or more, more preferably 0.12 mass % or more, still more preferably 0.18 mass % or more, particularly preferably 0.24 mass % or more, and most preferably 0.40 mass % or more, in terms of oxide.

For the same reason and the reason of improving the values of four-point bending strength and Weibull coefficient, the content of Ca is 3.40 mass % or less, preferably 2.50 mass % or less, more preferably 1.80 mass % or less, still preferably 1.20 mass % or less, and particularly preferably 0.80 mass % or less.

The content of Ca in terms of oxide specifically means the content of CaO.

It is considered that an appropriate amount of Ca bonds particles that constitute the sintered body together, or dissolves in the particles and strengthens the particles themselves, thereby reducing the deterioration rate due to plasma and improving the plasma resistance.

<<Mg>>

For the reason that the present sintered body has excellent plasma resistance, the content of Mg is 12.9 mass % or more, preferably 13.2 mass % or more, more preferably 13.5 mass % or more, still more preferably 14.0 mass % or more, even more preferably 14.5 mass % or more, particularly preferably 15.0 mass % or more, and most preferably 15.5 mass % or more, in terms of oxide.

For the same reason, the content of Mg is preferably 17.5 mass % or less, more preferably 17.0 mass % or less, still more preferably 16.5 mass % or less, and particularly preferably 16.0 mass % or less, in terms of oxide.

The content of Mg in terms of oxide specifically means the content of MgO.

<<Al>>

In the present sintered body, when the amount of Al is too large, the amount of Mg is relatively decreased.

Therefore, from the viewpoint of ensuring the desired amount of Mg, the content of Al is preferably 40.0 mass % or less, more preferably 39.0 mass % or less, still more preferably 38.0 mass % or less, particularly preferably 37.5 mass % or less, and most preferably 37.0 mass % or less, in terms of oxide.

When the Al content is too high, the value of the Weibull coefficient tends to be small. Also from this point, the content of Al is preferably within the above range.

On the other hand, the lower limit is not particularly limited, and the content of Al is, for example, 30.0 mass % or more, preferably 33.0 mass % or more, more preferably 34.0 mass % or more, still more preferably 34.5 mass % or more, even more preferably 35.0 mass % or more, particularly preferably 35.5 mass % or more, and most preferably 36.0 mass % or more, in terms of oxide.

The content of Al in terms of oxide specifically means the content of Al₂O₃.

The contents of metal elements (elements belonging to the element group M1 and the element M2, excluding Si) in the sintered body are measured using inductively coupled plasma mass spectrometry (ICP-MS).

Specifically, a sample is immersed in an extract of HF:HNO₃=4:1 (mass ratio) for 2 days and then heated at 80° C. for 1 hour. Thereafter, the sample is taken out using tweezers to obtain an extract in which the metal elements are extracted from the sample. The extract is dried and then the volume is adjusted to 10 mL using a HNO₃ solution, followed by analysis using an apparatus (Agient 8800) manufactured by Agilent Technologies Inc.

<<Si>>

The content of Si is preferably 43.0 mass % or more, more preferably 44.0 mass % or more, still more preferably 45.0 mass % or more, even more preferably 46.0 mass % or more, particularly preferably 46.5 mass % or more, and most preferably 47.0 mass % or more, in terms of oxide.

On the other hand, the content of Si is preferably 55.0 mass % or less, more preferably 51.0 mass % or less, still more preferably 50.0 mass % or less, particularly preferably 49.0 mass % or less, and most preferably 48.0 mass % or less, in terms of oxide.

The content of Si in terms of oxide specifically means the content of SiO₂.

The content of Si in the sintered body is obtained as follows.

First, a powder sample is taken from the center of the sintered body by grinding, and a total oxygen amount Z1 in the sintered body is obtained by an infrared absorption method using an oxygen/hydrogen analyzer (ROH-600 manufactured by LECO Corporation).

An oxygen amount Z3 is calculated by subtracting an oxygen amount Z2 bound to the elements (excluding silicon atoms) contained in the sintered body in the stoichiometric composition from the total oxygen amount Z1 in the sintered body. That is, oxygen amount Z3=total oxygen amount Z1−oxygen amount Z2.

Assuming that the entire oxygen amount Z3 has been used for bonding with silicon atoms, the oxygen amount Z3 is converted to the amount of SiO₂. The amount in terms of SiO₂ thus obtained is defined as the content of Si in terms of oxide (content of SiO₂) in the sintered body.

<Element M2>

In the present sintered body, the content of metal elements other than the elements belonging to the above element group M1 (that is, impurities) is small. Accordingly, the present sintered body has excellent plasma resistance and excellent thermal shock resistance.

Specifically, the content of the element M2, which is a metal element other than the elements belonging to element group M1, is 1.5 mass % or less, preferably 1.1 mass % or less, more preferably 0.7 mass % or less, still more preferably 0.5 mass % or less, even more preferably 0.3 mass % or less, particularly preferably 0.2 mass % or less, and most preferably 0.1 mass % or less, in terms of oxide. The lower limit is preferably zero (0 mass %).

Examples of the element M2 include at least one element selected from the group consisting of titanium (Ti), iron (Fe), nickel (Ni), chromium (Cr), manganese (Mn) and an alkali metal.

<<Ti>>

For the reason that the present sintered body has further excellent plasma resistance, the content of Ti is preferably 0.5 mass % or less, more preferably 0.3 mass % or less, still more preferably 0.2 mass % or less, even more preferably 0.1 mass % or less, particularly preferably 0.05 mass % or less, and most preferably 0.03 mass % or less, in terms of oxide.

The content of Ti in terms of oxide specifically means the content of TiO₂.

<<Fe, Ni, Cr, and Mn>>

The total content of Fe, Ni, Cr, and Mn is preferably 0.6 mass % or less, more preferably 0.4 mass % or less, still more preferably 0.3 mass % or less, even more preferably 0.2 mass % or less, particularly preferably 0.1 mass % or less, and most preferably 0.05 mass % or less, in terms of oxide.

In this case, the generation of foreign particles, which will be described later, is prevented, the four-point bending strength and the Weibull coefficient are improved, and the thermal shock resistance of the present sintered body is more excellent.

The content of Fe in terms of oxide specifically means the content of Fe₂O₃.

The content of Ni in terms of oxide specifically means the content of NiO.

The content of Cr in terms of oxide specifically means the content of Cr₂O₃.

The content of Mn in terms of oxide specifically means the content of MnO.

<<Alkali Metal>>

For the reasons that the present sintered body has a lower porosity and that the present sintered body has further excellent plasma resistance and thermal shock resistance, the content of the alkali metal is preferably 0.30 mass % or less, more preferably 0.20 mass % or less, still more preferably 0.15 mass % or less, particularly preferably 0.12 mass % or less, and most preferably 0.09 mass % or less, in terms of oxide.

However, for the same reason, it is preferable to contain some alkali metals. Specifically, the content of the alkali metal is preferably 0.01 mass % or more, and more preferably 0.03 mass % or more, in terms of oxide.

Examples of the alkali metal include lithium (Li), sodium (Na), and potassium (K).

The content of Li in terms of oxide specifically means the content of Li₂O.

The content of Na in terms of oxide specifically means the content of Na₂O.

The content of K in terms of oxide specifically means the content of K₂O.

<<Other Elements>>

In addition, examples of the element M2 include elements such as copper (Cu), zinc (Zn), zirconium (Zr), gallium (Ga), phosphorus (P), and sulfur (S). Although P and S are not metal elements, they are regarded as metal elements when treated as the element M2.

The total content of other elements is preferably 0.04 mass % or less, more preferably 0.04 mass % or less, and still more preferably 0.03 mass % or less in terms of oxide.

The content of Cu in terms of oxide specifically means the content of CuO.

The content of Zn in terms of oxide specifically means the content of ZnO.

The content of Zr in terms of oxide specifically means the content of ZrO₂.

The content of Ga in terms of oxide specifically means the content of Ga₂O₃.

The content of P in terms of oxide specifically means the content of P₂O₅.

The content of S in terms of oxide specifically means the content of SO₃.

<Porosity>

For the reason that the present sintered body has excellent plasma resistance and thermal shock resistance, the porosity of the present sintered body is 3.0 vol % or less, preferably 1.5 vol % or less, more preferably 0.5 vol % or less, still more preferably 0.3 vol % or less, particularly preferably 0.1 vol % or less, and most preferably 0.05 vol % or less. The lower limit is preferably zero (0 vol %).

In order to keep the porosity within the above range, it is preferable to set the content of each component as described above and to produce the sintered body by a method described later (the present production method).

In particular, a cordierite powder produced by an electric melting method is preferably used as a raw material powder.

The porosity is obtained according to the open porosity calculation method described in JIS R 1634:1998 “Method for measuring sintered body density and open porosity of fine ceramics”.

<Four-Point Bending Strength>

For the reason that the present sintered body has excellent thermal shock resistance, the four-point bending strength of the present sintered body is 170 MPa or more, preferably 180 MPa or more, more preferably 190 MPa or more, still more preferably 200 MPa or more, even more preferably 210 MPa or more, particularly preferably 220 MPa or more, and most preferably 230 MPa or more.

The upper limit is not particularly limited, and the four-point bending strength of the present sintered body is, for example, 300 MPa or less, and preferably 250 MPa or less.

The four-point bending strength is measured at 25° C. on a sintered body test piece (flat plate shape, length: 50 mm, width: 4 mm, thickness: 3 mm) according to JIS R 1601 (2008).

In order to keep the four-point bending strength within the above range, it is preferable to set the content of each component as described above and to produce the sintered body by the method described later (the present production method).

In particular, when the content of Fe, Ni, Cr, and Mn is high, it is difficult to obtain such four-point bending strength.

<Weibull Coefficient>

For the reason that the present sintered body has excellent thermal shock resistance, the Weibull coefficient of the present sintered body is 9.5 or more, preferably 10.0 or more, more preferably 10.5 or more, still more preferably 11 or more, even more preferably 11.5 or more, particularly preferably 12 or more, and most preferably 12.5 or more.

The upper limit is not particularly limited, and the Weibull coefficient of the present sintered body is, for example, 14 or less, and preferably 13 or less.

The Weibull coefficient (Weibull coefficient of four-point bending strength) is an index indicating the degree of a variation in four-point bending strength, and the larger the value, the smaller the variation in four-point bending strength.

The Weibull coefficient is obtained as follows. First, the four-point bending strength of 30 test pieces is measured by the method described above. Next, the Weibull coefficient is calculated according to JIS R 1625 (2010) using the 30 measured bending strength data.

In order to keep the Weibull coefficient within the above range, it is preferable to set the content of each component as described above and to produce the sintered body by the method described later (the present production method).

In particular, when the content of Fe, Ni, Cr, and Mn is high, it is difficult to obtain such a Weibull coefficient.

<Thermal Conductivity>

For the reason that the present sintered body has further excellent thermal shock resistance, the thermal conductivity of the present sintered body is preferably 4.0 W/(mK) or more, more preferably 4.2 W/(mK) or more, still more preferably 4.4 W/(mK) or more, even more preferably 4.6 W/(mK) or more, particularly preferably 4.8 W/(mK) or more, and most preferably 5.0 W/(mK) or more.

The upper limit is not particularly limited, and the thermal conductivity of the present sintered body is, for example, 6.0 W/(mK) or less, and preferably 5.5 W/(mK) or less.

The thermal conductivity is measured under the condition of 21° C. using a laser flash method thermophysical property measuring device “Xenon Flash Analyzer LFA 467 HyperFlash”, manufactured by NETZSCH, on a sintered body test piece (a plate shape with 12 mm×12 mm, thickness: 6.0 mm).

In order to keep the thermal conductivity within the above range, it is preferable to set the content of each component as described above and to produce the sintered body by a method described later (the present production method). Thus, it is preferable to obtain a dense sintered body with reduced amount of impurities.

<Heterogeneous Phase Amount (Number of Foreign Particles)>

The sintered body is observed using a scanning electron microscope (SEM) at a magnification of 1,000 times to obtain SEM images of any 50 fields of view.

Foreign particles containing the element M2 (particles composed of the element M2) are identified in the obtained SEM images using an EDX (energy dispersive X-ray spectroscopy) device attached to the SEM. Among specified foreign particles, the number of foreign particles having an equivalent circle diameter of 5 μm or more (unit: particles/cm²) is measured, and the average value in 50 fields of view is obtained. The obtained average value is taken as the number of foreign particles in the sintered body. In addition, in the present description, the number of such foreign particles may be referred to as a “heterogeneous phase amount” for convenience.

For the reason that the present sintered body has good four-point bending strength and Weibull coefficient and further excellent thermal shock resistance, the heterogeneous phase amount, that is, the number of foreign particles containing the element M2 and having an equivalent circle diameter of 5 μm or more is preferably 150/cm² or less, more preferably 100/cm² or less, still more preferably 50/cm² or less, even more preferably 30/cm² or less, particularly preferably 10/cm² or less, and most preferably 5/cm² or less. The lower limit is preferably zero (0/cm²).

In order to keep the heterogeneous phase amount within the above range, it is preferable to set the content of each component as described above and to produce the sintered body by a method described later (the present production method).

<Shape and Use>

The shape of the present sintered body may be a plate shape (for example, a disc shape, a flat plate shape), a spherical shape, a spheroidal shape, etc., and is appropriately selected according to the use.

The present sintered body is preferably used as a susceptor material for supporting wafers in a semiconductor production device, but the use of the present sintered body is not limited to this.

[Method for Producing Sintered Body]

Next, a method for producing the present sintered body (hereinafter, also referred to as “the present production method”) will be described.

The present production method is, roughly speaking, a method of producing a molded body using a raw material powder and heating the molded body.

Hereinafter, the present production method will be described in detail.

<Raw Material Powder>

As the raw material powder, a mixed powder containing a cordierite powder produced by an electric melting method, a mullite powder, and a magnesia powder is used.

<<Cordierite Powder>>

The cordierite (2MgO·2Al₂O₃·5SiO₂) powder is a raw material containing Mg, Al and Si which constitute the present sintered body.

Further, the cordierite powder may contain Ca as an impurity, and in this case, Ca constituting the present sintered body is supplied.

(Electrically Melted Cordierite Powder)

In the present production method, a cordierite powder produced by an electric melting method (also referred to as an “electrically melted cordierite powder” for convenience) is used.

A method for obtaining the electrically melted cordierite powder is schematically as follows, for example.

First, a raw material of the electrically melted cordierite powder is charged into a crucible. Examples of the raw material of the electrically melted cordierite powder include magnesia (MgO), alumina (Al₂O₃), and silica (SiO₂). These raw materials may contain impurities such as Ca.

Next, the raw material in the crucible is melted by generating plasma using, for example, a carbon electrode.

Thereafter, the molten raw material is air crushed and quenched.

Accordingly, an electrically melted cordierite powder is obtained. The electrically melted cordierite powder is a substance (powder) containing mainly amorphous and containing some crystals. Particles constituting the electrically melted cordierite powder are spherical and uniform in particle size. That is, they are homogeneous.

Therefore, the electrically melted cordierite powder is easily sintered in the presence of a mullite powder as a sintering aid, which will be described later. That is, the sinterability is good. As a result, a dense sintered body can be obtained and the porosity can be reduced. Further, impurities such as Ti can be reduced by production using the electric melting method.

Commercial products can be used as the electrically melted cordierite powder, and a specific example thereof is preferably ELP-150FINE (manufactured by AGC Ceramics Co., Ltd.).

<<Mullite Powder>>

Mullite is represented by chemical formulas such as 3Al₂O₃·2SiO₂ and 2Al₂O₃·SiO₂. The mullite powder is used as a sintering aid. By using the mullite powder as a sintering aid, a dense sintered body can be obtained.

The mullite powder is a raw material containing Al and Si which constitute the present sintered body.

<<Magnesia Powder>>

The magnesia (MgO) powder is a raw material containing Mg constituting the present sintered body.

As described above, since the present sintered body has a higher content of Mg than general cordierite, the magnesia powder is further used as the raw material powder.

<<Calcium Oxide Powder>>

The raw material powder can further contain a calcium oxide (CaO) powder.

As described above, the present sintered body further contains Ca in addition to the cordierite. Therefore, when Ca contained in the cordierite powder as an impurity is insufficient, the calcium oxide powder is further used as the raw material powder.

<<Magnetic Separation>>

Each powder used as the raw material powder, particularly the electrically melted cordierite powder, is preferably subjected to magnetic separation before use.

Accordingly, in the present sintered body finally obtained, the content of the element M2 (Ti, Fe, etc.), which is a metal element other than the elements (Ca, Mg, Al, and Si) belonging to the element group M1, can be reduced.

As a magnetic separation method, for example, a method using a wet magnetic filter can be preferably used. The magnetic separation conditions are not particularly limited, and may be appropriately adjusted, for example, such that the present sintered body obtained has a desired content of the element M2.

<<Preparation of Raw Material Powder>>

The powders described above are subjected to magnetic separation, if necessary, and then mixed. Accordingly, a raw material powder, which is a mixed powder of respective powders, is obtained. The mixing method is not particularly limited, and known methods can be employed.

The content of each powder in the raw material powder (mixed powder) is appropriately adjusted such that the content of each component in the present sintered body finally obtained is a desired amount.

The mixed powder is preferably pulverized to reduce the particle diameter from the viewpoint of improving the sinterability during heating, which will be described later. Specifically, the average particle diameter of the mixed powder after pulverization is preferably 10 μm or less, and more preferably 2 μm or less. The average particle diameter is a particle diameter (D₅₀) at an integrated value of 50% in the particle size distribution determined by a laser diffraction/scattering method (hereinafter the same).

The pulverization method is not particularly limited, and pulverization can be performed using a ball mill, an attritor, a bead mill, a jet mill, or the like.

In the case of wet pulverization, the mixed powder after pulverization is dried.

<Preparation of Molded Body>

Next, a molded body is produced using the raw material powder (mixed powder). That is, molding is performed.

The molding method is not particularly limited, and a general molding method can be used. For example, molding is performed using a hydrostatic press at a pressure of 100 MPa or more and 200 MPa or less.

As another method, a mixture obtained by adding an organic binder to the mixed powder may be molded into a predetermined shape by press molding, extrusion molding, sheet molding, or the like.

The shape obtained by molding is appropriately selected according to the use of the obtained sintered body.

<Heating>

Next, the obtained molded body is heated. Accordingly, a sintered body is obtained.

From the viewpoint of improving the sinterability, the heating temperature (maximum temperature during heating) is preferably 1400° C. or higher, more preferably 1410° C. or higher, and still more preferably 1430° C. or higher.

On the other hand, when the heating temperature is too high, a part of the obtained sintered body may be melted and broken, or a sintered body having desired dimensions may not be obtained. Therefore, the heating temperature is preferably 1450° C. or lower, and more preferably 1440° C. or lower.

The heating time (holding time at the maximum temperature) is preferably 1 hour or longer, more preferably 2 hours or longer, and still more preferably 5 hours or longer.

On the other hand, the heating time is preferably 48 hours or shorter, more preferably 12 hours or shorter, and still more preferably 8 hours or shorter.

The atmosphere during heating (heating atmosphere) is not particularly limited, and examples thereof include: an air atmosphere; an inert atmosphere such as a nitrogen or argon atmosphere; and a reducing atmosphere such as a hydrogen atmosphere or a mixed atmosphere of hydrogen and nitrogen.

The obtained sintered body is preferably densified. The densification is performed using, for example, a hot isostatic press.

Specifically, for example, a hot isostatic press is used to apply a pressure of 100 MPa or more and 200 MPa or less while heating at a temperature of 1000° C. or higher and 1350° C. or lower.

### EXAMPLES

Hereinafter, the present invention will be specifically described with reference to Examples. However, the present invention is not limited to Examples described below.

In the following, Examples 1 and 2, 5 to 9, 11 and 12, 14 to 17, 19 to 21, and 23 to 25 are Working Examples and Examples 3 and 4, 10, 13, 18, and 22 are Comparative Examples.

### Examples 1 to 25

A sintered body in each example was obtained in the following manner.

<<Raw Material Powder>>

An electrically melted cordierite (2MgO·2Al₂O₃·5SiO₂) powder, a mullite (3Al₂O₃·2SiO₂) powder as a sintering aid, a magnesia (MgO) powder, and a calcium oxide (CaO) powder were mixed.

As the electrically melted cordierite powder, “ELP-150FINE” (average particle diameter: 14.1 μm) manufactured by AGC Ceramics Co., Ltd. was used.

As the mullite powder, “KM101” (average particle diameter: 0.8 μm) manufactured by KCM Corporation was used.

Specifically, the respective powders were mixed such that the contents of the element belonging to the element group M1 and the element M2 in the obtained sintered body were the values shown in Tables 1 to 3 below to obtain raw material powders as mixed powders.

At this time, another metal oxide powder such as a titanium oxide (TiO₂) powder was added as necessary.

Each powder was subjected to magnetic separation before mixing. Specifically, a slurry (concentration: 15 vol %) in which each powder was dispersed in water was subjected to magnetic separation three times using a wet magnetic filter (“wet type high magnetic flux tester FG type” manufactured by NIPPON MAGNETIC DRESSING CO., LTD.) under conditions of 2.8 tesla.

However, in Examples 16 to 18, magnetic separation was not performed for each powder.

The raw material powder (mixed powder) was wet-mixed and pulverized with ethanol as a dispersion medium using a ball mill having high-purity alumina balls. The raw material powder after pulverization has an average particle diameter (D₅₀) of 2.0 μm.

<<Preparation of Molded Body and Heating>>

The obtained raw material powder (mixed powder) was pressurized at room temperature at a pressure of 180 MPa using a hydrostatic press to produce a molded body.

Next, the prepared molded body was heated in the atmosphere, to obtain a sintered body. The heating temperature was 1430° C. and the heating time was 5 hours.

The obtained sintered body was densified. Specifically, the obtained sintered body was heated at 1300° C. while being applied with a pressure of 145 MPa using a hot isostatic press. However, in Examples 24 and 25, densification was not performed.

<Content of Elements Belonging to Element Group M1 and Element M2>

Regarding the sintered body in each example, the contents of the elements belonging to the element group M1 and the element M2 in terms of oxide were obtained by the method described above. Results are shown in Tables 1 to 3 below.

<Porosity Etc.>

Regarding the sintered body in each example, the porosity, the heterogeneous phase amount, the four-point bending strength, the Weibull coefficient, and the thermal conductivity were obtained by the methods described above. Results are shown in Tables 1 to 3 below.

<Thermal Shock Resistance Test>

A test piece having a size of 15 mm×5 mm×100 mm was cut out from the sintered body.

The test piece was heated at 350° C. for 60 minutes and then dropped into room temperature water. Next, the test piece was taken out of the water, and cracks in the test piece were stained with a dye penetrant flaw detector (penetrant FP-S and developer FD-S manufactured by Taseto Co., Ltd.) and visually observed.

In Tables 1 to 3 below, a case where no crack having a length of 3 mm or more was observed was recorded as “A”, a case where 1 to 2 cracks having a length of 3 mm or more were observed was recorded as “B”, and a case where 3 or more cracks having a length of 3 mm or more were observed was recorded as “C”.

“A” or “B” was evaluated to be excellent in thermal shock resistance.

<Etching Amount>

For the sintered body in each example, the etching amount was obtained to evaluate the plasma resistance.

Specifically, a test piece having a size of 10 mm×5 mm×4 mm was cut out from the sintered body, and a surface of 10 mm×5 mm was mirror-finished. A Kapton (registered trademark) tape was applied as a mask to a part of the mirror-finished surface, and etching was performed with plasma gas. Thereafter, the etching amount was obtained by measuring a difference in height between the etched portion and the non-etched portion by using a stylus surface shape measuring apparatus (Dectak 150, manufactured by ULVAC, Inc.).

As a plasma etching device, EXAM (model: POEM, manufactured by SHINKO SEIKI CO., LTD.) was used. Etching was performed with CF₄ gas for 390 minutes under a pressure of 10 Pa and an output of 350 W in a RIE mode (reactive ion etching mode).

It can be evaluated that the smaller the etching amount (unit: nm), the better the plasma resistance.

Specifically, when the etching amount was 420 nm or less, the plasma resistance was evaluated to be excellent.

TABLE 1

| | | | Ex. 1 | Ex. 2 | Ex. 3 | Ex. 4 | Ex. 5 |
|---|---|---|---|---|---|---|---|
| M1 | CaO | mass % | 0.104 | 0.097 | 0.123 | 0.022 | 0.452 |
| | MgO | mass % | 14.655 | 14.900 | 12.545 | 14.355 | 15.221 |
| | Al₂O₃ | mass % | 37.103 | 36.874 | 37.572 | 37.222 | 37.032 |
| | SiO₂ | mass % | 47.887 | 47.823 | 49.529 | 48.088 | 47.201 |
| M2 | TiO₂ | mass % | 0.023 | 0.052 | 0.024 | 0.045 | 0.024 |
| | Fe₂O₃ | mass % | 0.044 | 0.089 | 0.047 | 0.078 | 0.018 |
| | NiO | mass % | 0.007 | 0.012 | 0.002 | 0.007 | 0.000 |
| | Cr₂O₃ | mass % | 0.000 | 0.003 | 0.000 | 0.002 | 0.000 |
| | MnO | mass % | 0.005 | 0.000 | 0.000 | 0.004 | 0.002 |
| | Li₂O | mass % | 0.000 | 0.001 | 0.000 | 0.002 | 0.000 |
| | Na₂O | mass % | 0.100 | 0.121 | 0.093 | 0.098 | 0.012 |
| | K₂O | mass % | 0.008 | 0.006 | 0.005 | 0.007 | 0.003 |
| | La₂O₃ | mass % | 0.052 | 0.006 | 0.048 | 0.055 | 0.023 |
| | Others | mass % | 0.012 | 0.016 | 0.012 | 0.015 | 0.012 |

| | | | | | | |
|---|---|---|---|---|---|---|
| Fe₂O₃ + NiO + Cr₂O₃ + MnO | mass % | 0.056 | 0.104 | 0.049 | 0.091 | 0.020 |
| Li₂O + Na₂O + K₂O | mass % | 0.108 | 0.128 | 0.098 | 0.107 | 0.015 |
| Total M2 | mass % | 0.251 | 0.306 | 0.231 | 0.313 | 0.094 |
| Total M1 + M2 | mass % | 100.000 | 100.000 | 100.000 | 100.000 | 100.000 |
| Porosity | vol % | 0.06 | 0.00 | 0.02 | 0.03 | 0.01 |
| Heterogeneous phase | Particles/ | 6 | 24 | 8 | 31 | 4 |
| amount | cm² | | | | | |
| Four-point bending strength | MPa | 231 | 226 | 221 | 232 | 207 |
| Weibull coefficient | — | 12.7 | 12.4 | 11.9 | 13.1 | 12.2 |
| Thermal conductivity | W/(m · K) | 4.8 | 4.5 | 4.2 | 4.7 | 5.2 |
| Thermal shock resistance | — | A | A | A | A | A |
| test | | | | | | |
| Etching amount | nm | 372 | 375 | 456 | 422 | 348 |

| | | | Ex. 6 | Ex. 7 | Ex. 8 | Ex. 9 |
|---|---|---|---|---|---|---|
| M1 | CaO | mass % | 0.247 | 1.602 | 0.795 | 2.864 |
| | MgO | mass % | 15.751 | 13.236 | 13.876 | 12.923 |
| | Al₂O₃ | mass % | 37.224 | 36.934 | 35.979 | 37.031 |
| | SiO₂ | mass % | 46.562 | 48.022 | 49.142 | 46.941 |
| M2 | TiO₂ | mass % | 0.028 | 0.012 | 0.017 | 0.019 |
| | Fe₂O₃ | mass % | 0.054 | 0.053 | 0.032 | 0.031 |
| | NiO | mass % | 0.000 | 0.002 | 0.003 | 0.000 |
| | Cr₂O₃ | mass % | 0.000 | 0.002 | 0.000 | 0.000 |
| | MnO | mass % | 0.000 | 0.002 | 0.000 | 0.000 |
| | Li₂O | mass % | 0.000 | 0.000 | 0.001 | 0.000 |
| | Na₂O | mass % | 0.087 | 0.036 | 0.074 | 0.102 |
| | K₂O | mass % | 0.005 | 0.008 | 0.002 | 0.004 |
| | La₂O₃ | mass % | 0.028 | 0.078 | 0.064 | 0.072 |
| | Others | mass % | 0.014 | 0.013 | 0.015 | 0.013 |

| | | | | | |
|---|---|---|---|---|---|
| Fe₂O₃ + NiO + Cr₂O₃ + MnO | mass % | 0.054 | 0.059 | 0.035 | 0.031 |
| Li₂O + Na₂O + K₂O | mass % | 0.092 | 0.044 | 0.077 | 0.106 |
| Total M2 | mass % | 0.216 | 0.206 | 0.208 | 0.241 |
| Total M1 + M2 | mass % | 100.000 | 100.000 | 100.000 | 100.000 |
| Porosity | vol % | 0.09 | 0.11 | 0.07 | 0.31 |
| Heterogeneous phase | Particles/ | 10 | 10 | 9 | 8 |
| amount | cm² | | | | |
| Four-point bending strength | MPa | 199 | 201 | 221 | 188 |
| Weibull coefficient | — | 13.1 | 11.2 | 11.5 | 10.5 |
| Thermal conductivity | W/(m · K) | 5.0 | 4.5 | 4.5 | 4.7 |
| Thermal shock resistance | — | B | A | A | B |
| test | | | | | |
| Etching amount | nm | 357 | 385 | 369 | 398 |

TABLE 2

| | | | Ex. 10 | Ex. 11 | Ex. 12 | Ex. 13 | Ex. 14 |
|---|---|---|---|---|---|---|---|
| M1 | CaO | mass % | 6.876 | 0.087 | 0.074 | 0.039 | 0.092 |
| | MgO | mass % | 12.569 | 16.432 | 14.956 | 14.874 | 15.022 |
| | Al₂O₃ | mass % | 37.072 | 35.653 | 37.025 | 37.012 | 36.087 |
| | SiO₂ | mass % | 43.252 | 47.514 | 47.552 | 47.597 | 48.115 |
| M2 | TiO₂ | mass % | 0.024 | 0.087 | 0.212 | 0.256 | 0.472 |
| | Fe₂O₃ | mass % | 0.047 | 0.077 | 0.043 | 0.052 | 0.047 |
| | NiO | mass % | 0.002 | 0.011 | 0.002 | 0.000 | 0.000 |
| | Cr₂O₃ | mass % | 0.000 | 0.002 | 0.002 | 0.000 | 0.000 |
| | MnO | mass % | 0.000 | 0.000 | 0.000 | 0.001 | 0.000 |
| | Li₂O | mass % | 0.000 | 0.001 | 0.000 | 0.000 | 0.000 |
| | Na₂O | mass % | 0.093 | 0.114 | 0.089 | 0.083 | 0.093 |
| | K₂O | mass % | 0.005 | 0.003 | 0.004 | 0.004 | 0.009 |
| | La₂O₃ | mass % | 0.048 | 0.006 | 0.032 | 0.067 | 0.053 |
| | Others | mass % | 0.012 | 0.013 | 0.009 | 0.015 | 0.010 |

| | | | | | | |
|---|---|---|---|---|---|---|
| Fe₂O₃ + NiO + Cr₂O₃ + MnO | mass % | 0.049 | 0.090 | 0.047 | 0.053 | 0.047 |
| Li₂O + Na₂O + K₂O | mass % | 0.098 | 0.118 | 0.093 | 0.087 | 0.102 |
| Total M2 | mass % | 0.231 | 0.314 | 0.393 | 0.478 | 0.684 |
| Total M1 + M2 | mass % | 100.000 | 100.000 | 100.000 | 100.000 | 100.000 |
| Porosity | vol % | 0.51 | 0.01 | 0.03 | 0.04 | 0.06 |
| Heterogeneous phase | Particles/ | 20 | 18 | 33 | 41 | 37 |
| amount | cm² | | | | | |
| Four-point bending strength | MPa | 169 | 201 | 232 | 218 | 223 |
| Weibull coefficient | — | 9.3 | 10.7 | 12.2 | 12.2 | 12.8 |
| Thermal conductivity | W/(m · K) | 4.2 | 4.2 | 5.1 | 5.0 | 4.7 |
| Thermal shock resistance | — | C | A | A | A | A |
| test | | | | | | |
| Etching amount | nm | 423 | 350 | 384 | 421 | 399 |

| | | | Ex. 15 | Ex. 16 | Ex. 17 | Ex. 18 |
|---|---|---|---|---|---|---|
| M1 | CaO | mass % | 0.102 | 0.100 | 0.112 | 0.047 |
| | MgO | mass % | 14.659 | 14.984 | 15.321 | 15.019 |
| | Al₂O₃ | mass % | 37.568 | 38.012 | 38.091 | 37.874 |
| | SiO₂ | mass % | 46.712 | 46.435 | 45.697 | 45.879 |
| M2 | TiO₂ | mass % | 0.762 | 0.054 | 0.032 | 0.017 |
| | Fe₂O₃ | mass % | 0.041 | 0.189 | 0.480 | 0.730 |
| | NiO | mass % | 0.002 | 0.045 | 0.052 | 0.022 |
| | Cr₂O₃ | mass % | 0.000 | 0.007 | 0.008 | 0.002 |
| | MnO | mass % | 0.003 | 0.008 | 0.002 | 0.006 |
| | Li₂O | mass % | 0.000 | 0.000 | 0.000 | 0.000 |
| | Na₂O | mass % | 0.077 | 0.092 | 0.099 | 0.105 |
| | K₂O | mass % | 0.005 | 0.002 | 0.003 | 0.008 |
| | La₂O₃ | mass % | 0.058 | 0.049 | 0.072 | 0.273 |
| | Others | mass % | 0.011 | 0.023 | 0.031 | 0.018 |

| | | | | | |
|---|---|---|---|---|---|
| Fe₂O₃ + NiO + Cr₂O₃ + MnO | mass % | 0.046 | 0.249 | 0.542 | 0.760 |
| Li₂O + Na₂O + K₂O | mass % | 0.082 | 0.094 | 0.102 | 0.113 |
| Total M2 | mass % | 0.959 | 0.469 | 0.779 | 1.181 |
| Total M1 + M2 | mass % | 100.000 | 100.000 | 100.000 | 100.000 |
| Porosity | vol % | 0.07 | 0.03 | 0.02 | 0.01 |
| Heterogeneous phase | Particles/ | 33 | 76 | 148 | 332 |
| amount | cm² | | | | |
| Four-point bending strength | MPa | 220 | 204 | 193 | 173 |
| Weibull coefficient | — | 12.3 | 10.5 | 9.9 | 9.2 |
| Thermal conductivity | W/(m · K) | 4.8 | 4.7 | 4.4 | 4.1 |
| Thermal shock resistance | — | A | A | B | C |
| test | | | | | |
| Etching amount | nm | 411 | 385 | 376 | 433 |

TABLE 3

| | | | Ex. 19 | Ex. 20 | Ex. 21 | Ex. 22 | Ex. 23 | Ex. 24 | Ex. 25 |
|---|---|---|---|---|---|---|---|---|---|
| M1 | CaO | mass % | 0.111 | 0.117 | 0.104 | 0.101 | 0.087 | 0.102 | 0.099 |
| | MgO | mass % | 15.785 | 14.653 | 14.655 | 14.892 | 14.155 | 14.635 | 14.912 |
| | Al₂O₃ | mass % | 33.642 | 38.811 | 39.903 | 41.435 | 36.103 | 37.093 | 36.745 |
| | SiO₂ | mass % | 50.214 | 46.202 | 45.077 | 43.349 | 49.104 | 47.926 | 47.959 |
| M2 | TiO₂ | mass % | 0.009 | 0.007 | 0.022 | 0.027 | 0.044 | 0.033 | 0.042 |
| | Fe₂O₃ | mass % | 0.044 | 0.033 | 0.045 | 0.038 | 0.057 | 0.034 | 0.088 |
| | NiO | mass % | 0.002 | 0.002 | 0.007 | 0.006 | 0.006 | 0.005 | 0.014 |
| | Cr₂O₃ | mass % | 0.000 | 0.002 | 0.000 | 0.001 | 0.001 | 0.000 | 0.003 |
| | MnO | mass % | 0.000 | 0.000 | 0.000 | 0.000 | 0.002 | 0.003 | 0.001 |
| | Li₂O | mass % | 0.000 | 0.000 | 0.000 | 0.001 | 0.001 | 0.000 | 0.003 |
| | Na₂O | mass % | 0.118 | 0.106 | 0.112 | 0.087 | 0.357 | 0.108 | 0.111 |
| | K₂O | mass % | 0.007 | 0.004 | 0.009 | 0.008 | 0.009 | 0.004 | 0.005 |
| | La₂O₃ | mass % | 0.057 | 0.050 | 0.052 | 0.044 | 0.057 | 0.045 | 0.005 |
| | Others | mass % | 0.011 | 0.013 | 0.014 | 0.011 | 0.017 | 0.012 | 0.013 |

| | | | | | | | | |
|---|---|---|---|---|---|---|---|---|
| Fe₂O₃ + NiO + Cr₂O₃ + MnO | mass % | 0.046 | 0.037 | 0.052 | 0.045 | 0.066 | 0.042 | 0.106 |
| Li₂O + Na₂O + K₂O | mass % | 0.125 | 0.110 | 0.121 | 0.096 | 0.367 | 0.112 | 0.119 |
| Total M2 | mass % | 0.248 | 0.217 | 0.261 | 0.223 | 0.551 | 0.244 | 0.285 |
| Total M1 + M2 | mass % | 100.000 | 100.000 | 100.000 | 100.000 | 100.000 | 100.000 | 100.000 |
| Porosity | vol % | 0.00 | 0.03 | 0.05 | 0.06 | 0.21 | 0.33 | 0.59 |
| Heterogeneous phase | Particles/ | 19 | 17 | 15 | 11 | 32 | 8 | 7 |
| amount | cm² | | | | | | | |
| Four-point bending strength | MPa | 200 | 206 | 209 | 211 | 201 | 204 | 189 |
| Weibull coefficient | — | 11.3 | 11.5 | 10.8 | 9.4 | 11.0 | 10.7 | 10.1 |
| Thermal conductivity | W/(m · K) | 4.4 | 5.1 | 5.3 | 4.6 | 4.3 | 4.8 | 4.6 |
| Thermal shock resistance | — | A | A | B | C | A | A | A |
| test | | | | | | | | |
| Etching amount | nm | 386 | 381 | 378 | 390 | 407 | 379 | 388 |

<Conclusion of Evaluation Results>

As shown in Tables 1 to 3, it is seen that the sintered bodies in Examples 1 and 2, 5 to 9, 11 and 12, 14 to 17, 19 to 21, and 23 to 25 have excellent plasma resistance and thermal shock resistance.

In contrast, the sintered bodies in Examples 3 and 4, 10, 13, 18 and 22 are insufficient in at least one of plasma resistance and thermal shock resistance.

The details are as follows.

In Example 3, the content of MgO is less than 12.9 mass %, the value of the etching amount is large, and the plasma resistance is insufficient.

In Example 4, the content of CaO is less than 0.06 mass %, the value of the etching amount is large, and the plasma resistance is insufficient.

In Example 10, the content of MgO is less than 12.9 mass %, the value of the etching amount is large, and the plasma resistance is insufficient.

Further, in Example 10, the content of CaO is more than 3.40 mass %, the four-point bending strength is less than 170 MPa, the Weibull coefficient is less than 9.5, and the thermal shock resistance is insufficient.

In Example 13, the content of CaO is less than 0.06 mass %, the value of the etching amount is large, and the plasma resistance is insufficient.

In Example 18, the content of CaO is less than 0.06 mass %, the value of the etching amount is large, and the plasma resistance is insufficient.

Further, in Example 18, the Weibull coefficient is less than 9.5, and the thermal shock resistance is insufficient.

In Example 22, the Weibull coefficient is less than 9.5, and the thermal shock resistance is insufficient.

Although the present invention has been described in detail with reference to specific embodiments, it is apparent to those skilled in the art that various changes and modifications can be made without departing from the spirit and scope of the present invention. The present application is based on a Japanese Patent Application (No. 2021-035458) filed on Mar. 5, 2021, the contents of which are incorporated herein by reference.

What is claimed is:

1. A cordierite sintered body comprising all elements belonging to an element group M1 consisting of calcium, magnesium, aluminum, and silicon,
wherein a content of the calcium is 0.06 mass % or more and 3.40 mass % or less in terms of oxide,
a content of the magnesium is 12.9 mass % or more in terms of oxide,
a content of an element M2, which is a metal element other than the elements belonging to the element group M1, is 1.5 mass % or less in terms of oxide,
a porosity is 3.0 vol % or less,
a four-point bending strength is 170 MPa or more, and
a Weibull coefficient is 9.5 or more.

2. The cordierite sintered body according to claim 1, wherein the content of the calcium is 0.09 mass % or more and 1.80 mass % or less in terms of oxide.

3. The cordierite sintered body according to claim 1, wherein a content of the aluminum is 39.0 mass % or less in terms of oxide.

4. The cordierite sintered body according to claim 1, wherein a content of titanium is 0.5 mass % or less in terms of oxide.

5. The cordierite sintered body according to claim 1, wherein a total content of iron, nickel, chromium, and manganese is 0.6 mass % or less in terms of oxide.

6. The cordierite sintered body according to claim 1, wherein a content of an alkali metal is 0.30 mass % or less in terms of oxide.

7. The cordierite sintered body according to claim 1, wherein a thermal conductivity is 4.0 W/(mK) or more.

8. The cordierite sintered body according to claim 1, wherein the number of foreign particles containing the element M2 and having an equivalent circle diameter of 5 μm or more is 150/cm² or less.

9. A method for producing the cordierite sintered body according to claim 1, the method comprising:
preparing a molded body using a raw material powder; and
heating the molded body,
wherein as the raw material powder, a mixed powder comprising a cordierite powder produced by an electric melting method, a mullite powder, and a magnesia powder is used.

10. The method for producing a cordierite sintered body according to claim 9, wherein the mixed powder further comprises a calcium oxide powder.

11. The method for producing a cordierite sintered body according to claim 9, wherein the cordierite powder is subjected to magnetic separation before use.
